(19) United States
(12) Patent Application Publication
(10) Pub. No.: US 2017/0172084 A1
(43) Pub. Date: Jun. 22, 2017

(54) SYSTEMS AND METHODS FOR HYDROPONIC GROWTH

(71) Applicant: JFM Managment, Inc., Scottsdale, AZ (US)

(72) Inventors: Jason C. Fox, Scottsdale, AZ (US); Todd M. Eide, Phoenix, AZ (US); Jeffrey R. Milley, Chandler, AZ (US)

(21) Appl. No.: 15/453,299

(22) Filed: Mar. 8, 2017

Related U.S. Application Data
(63) Continuation of application No. 14/884,063, filed on Oct. 15, 2015, now abandoned.
Application No. 14/884,063 is a continuation-in-part of application No. 14/228,695, filed on Mar. 28, 2014, now abandoned.

(51) Int. Cl. A01G 31/06; A01G 1/00; A01G 27/02; A01G 31/00; A01G 31/02

(52) U.S. Cl. CPC A01G 31/06; A01G 31/001; A01G 31/02; A01G 27/02; A01G 1/001

(57) ABSTRACT

Methods and apparatus for according to various aspects of the present invention comprise a growth tray configured to allow a liquid growth medium to be flowed from a first end to a second end. A tray system may be positioned within the growth tray to arrange a plurality of plants throughout the growth tray. A delivery system may be used to provide the liquid growth medium to the growth tray. A recirculation system may be configured to collect the liquid growth medium at the second end of the growth tray and recirculate the liquid growth medium to the first end for reuse. An aeration system may provide an individualized flow of a gas to each plant in the grid-like system. A flood system and/or top feed system may deliver a nutrient solution to the plurality of growth locations.

### CROSS-REFERENCES TO RELATED APPLICATIONS

This application is a continuation of prior U.S. patent application Ser. No. 14/884,063, filed Oct. 15, 2015, which is a continuation-in-part of prior U.S. patent application Ser. No. 14/228,695, filed Mar. 28, 2014, and incorporates the disclosure of all such applications by reference.

### BACKGROUND OF INVENTION

Plants may be grown hydroponically without soil by various methods. Hydroponics has several benefits including reduced use of water, the ability to reuse water, faster plant growth, and reduced likelihoods of disease. Many forms of hydroponic growing systems seek to replace the soil with another solid medium or expose bare plant roots to a liquid nutrient solution. One example is to flow the liquid nutrient solution past the plant roots in a manner that delivers an appropriate amount of nutrients to the plant without subjecting the roots to a static pool of fluid that might introduce disease, pests, or other unwanted toxins to the plant.

### SUMMARY OF THE INVENTION

Methods and apparatus for hydroponic growth according to various aspects of the present invention comprise a growth tray configured to allow a liquid growth medium to be flowed from a first end to a second end. A tray system may be positioned within the growth tray to arrange a plurality of plants throughout the growth tray. A delivery system may be used to provide the liquid growth medium to the growth tray such as by flowing the liquid growth medium down a waterfall system prior to introduction into the growth tray. An aeration system may be used to provide an individualized flow of a gas to each plant in the tray system. A recirculation system may be configured to collect the liquid growth medium at the second end of the growth tray and recirculate the liquid growth medium to the first end for reuse. A flood system may be used to deliver a nutrient solution to the plurality of growth locations. A top feed system may be used to deliver a nutrient solution to the plurality of growth locations. A lighting system may be used to provide light to the plants at the plurality of growth locations.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIGS. 1A and 1B representatively illustrate an isometric view of a hydroponic growth system in accordance with an exemplary embodiment of the present technology;

FIG. 2 representatively illustrates an isometric view of a hydroponic growth system with covers open and portions of trays removed in accordance with an exemplary embodiment of the present technology;

FIG. 3 representatively illustrates an isometric view of a hydroponic growth system with portions removed to show additional detail in accordance with an exemplary embodiment of the present technology;

FIG. 4 representatively illustrates an isometric view of a hydroponic growth system with a trellis system and a lighting system in accordance with an exemplary embodiment of the present technology;

FIGS. 5A and 5B representatively illustrate various embodiments of a tray system, in accordance with an exemplary embodiment of the present technology;

FIGS. 6A and 6B representatively illustrate various embodiments of a tray system, in accordance with an exemplary embodiment of the present technology;

FIG. 7 representatively illustrates an exploded view of a second end portion of the hydroponic growth system in accordance with an exemplary embodiment of the present technology;

FIG. 8 representatively illustrates an isometric view of a hydroponic growth system with a top drip system in accordance with an exemplary embodiment of the present technology; and

FIG. 9 representatively illustrates an isometric view of a hydroponic growth system with a waterfall removed in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of pumps, jets, nozzles, sprayers, filters, ducting, tubing, and the like, which may carry out a variety of functions. In addition, the present technology may be practiced in conjunction with any number of processes such as hydroponic growing techniques and the system described is merely one exemplary application for the technology. Further, the present technology may employ any number of conventional techniques or control systems for controlling light, flow rates, delivering fluids, circulating fluids, filtering materials, and/or aerating moving fluids.

System and methods for hydroponic growth according to various aspects of the present invention may operate in conjunction with any suitable fluid delivery system and/or nutritional materials or compounds. Various representative implementations of the present invention may be applied to any system for managing and/or controlling the growth of plants.

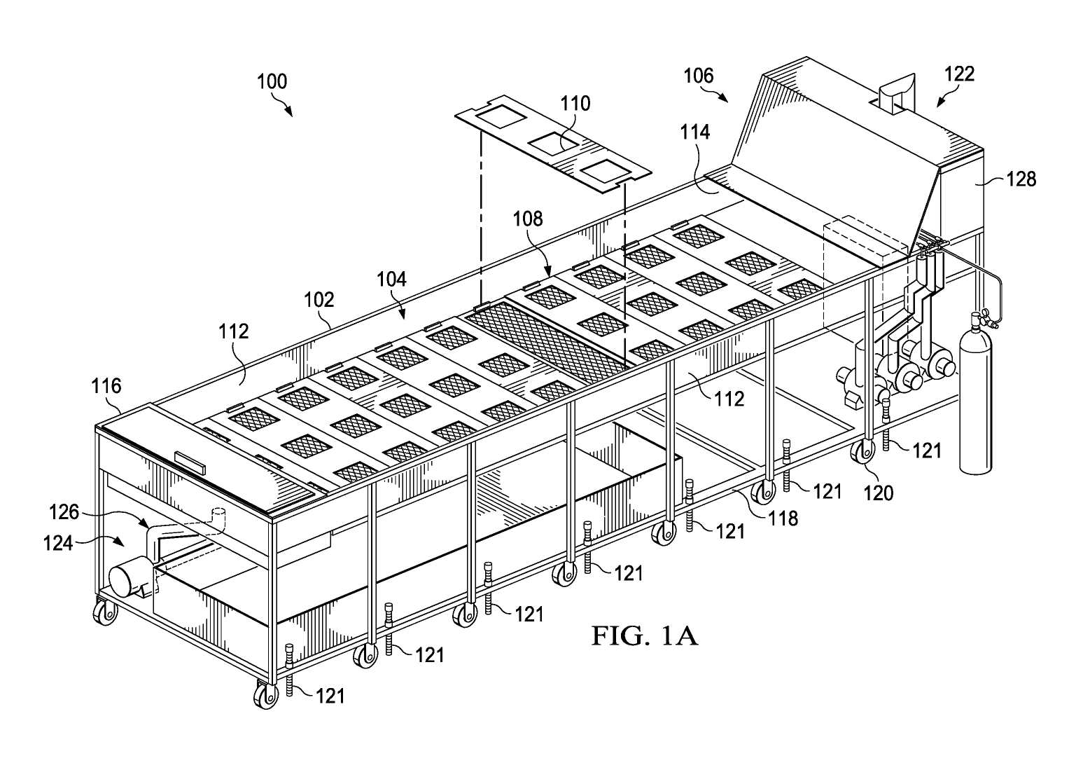

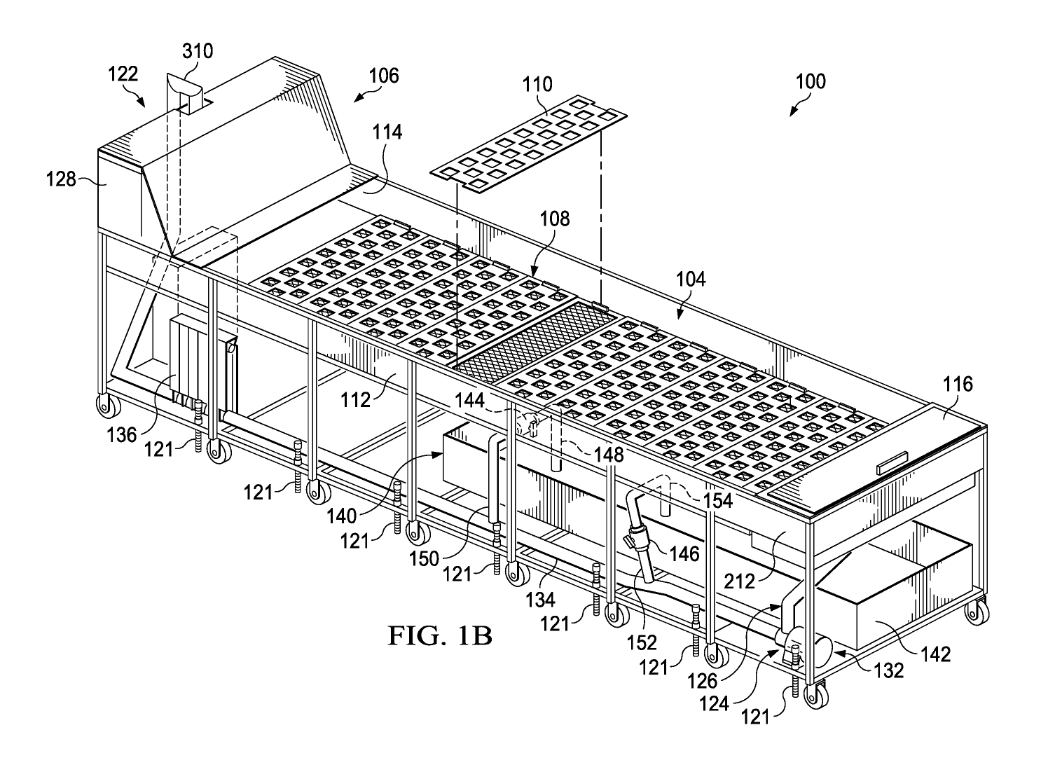

Referring now to FIG. 1A, in one embodiment, systems and methods for a hydroponic growth system 100 may comprise a growth tray 102 configured to provide a receiving area 104 and a delivery system 106 configured to provide a liquid growth medium to the receiving area 104. The hydroponic growth system 100 may further comprise a tray system 108 suitably configured provide a plurality of growth locations 110 for one or more plants.

The plant may comprise any suitable organism to be grown hydroponically such as a seed, a seedling, an established plant having a substantially exposed root system, or a plant with a root system that is contained in a plant medium. The plant medium may comprise any suitable medium, housing, container, and the like, which facilitates growth of the plant. For example, in one embodiment the plant may comprise an edible plant such as lettuce, tomato, radish, and the like.

The liquid growth medium may be a liquid solution that is provided as a nutrient source for the plant. The liquid growth medium may comprise any suitable material or compound for growing the plant and may be selected according to any suitable criteria. For example, in one embodiment, the liquid growth medium may comprise water. The water may be filtered to remove any undesirable chemicals or the water may be specifically enhanced to contain desired chemicals and/or nutrients. In a second embodiment, the liquid growth medium may comprise a water solution mixed with a nutrient compound selected according to a type of plant being grown.

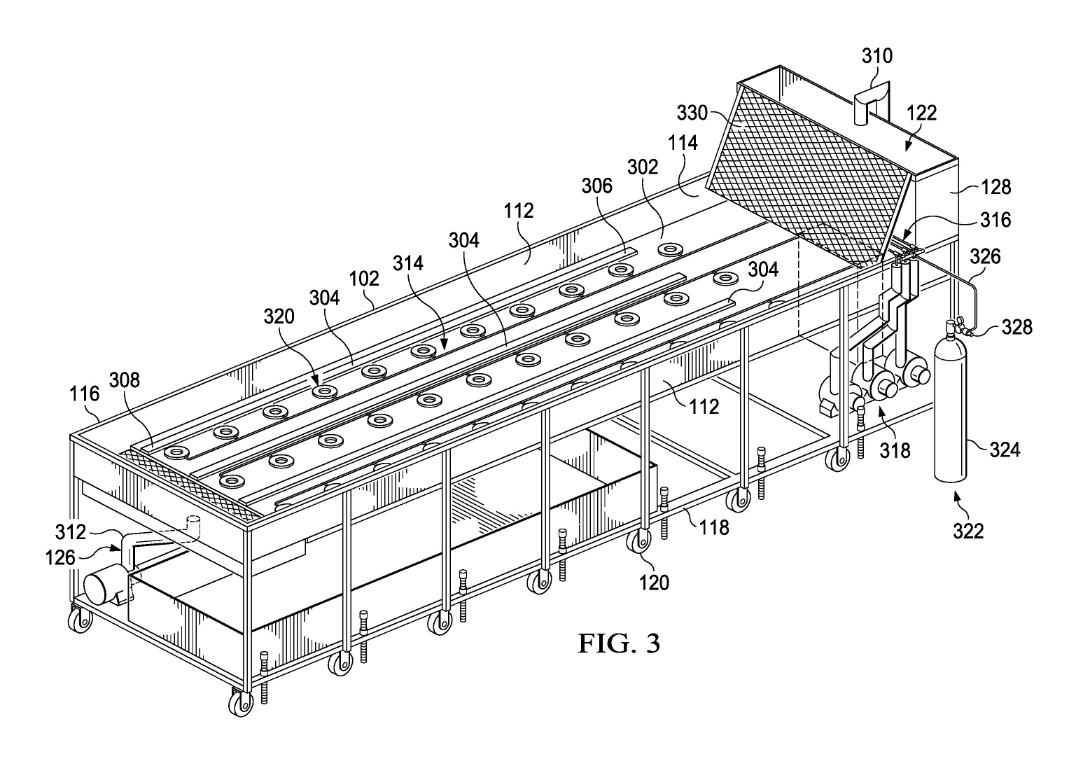

The growth tray 102 provides a substantially horizontal recessed surface suitably configured to provide a flow path for the liquid growth medium and a housing area for the one or more plant. The growth tray 102 may comprise any suitable system or device for receiving and housing the plant. For example, in one embodiment, the growth tray 102 may comprise a substantially rectangular structure having a pair of opposing sidewall elements 112 that extend between a first end 114 and a second end 116. Referring now to FIGS. 1A and 3, the growth tray 102 may further comprise a floor section 302 extending between lower portions of the generally opposing sidewall elements 112 and the first and second ends 114, 116 to form the receiving area 104.

The growth tray 102 may comprise any suitable size and/or dimensions. The growth tray 102 may be sized according to the type of plant being grown by taking into account the expected dimensions of a fully grown plant to minimize crowding and/or to facilitate harvesting. In one embodiment, the growth tray 102 may comprise a length that is substantially larger than its width to facilitate the flow of the liquid growth medium between the first and second ends 114, 116. For example, the growth tray 102 may comprise a length of between about ten and sixty feet and a width of between about two and five feet.

The growth tray 102 may also comprise any suitable material such as metal, plastic, stone, or composite. The material may be selected according to any suitable criteria such as weight, cost, heat transfer properties, and/or ability of the material to be exposed to the liquid growth medium without reacting. For example, a material such as high grade stainless steel may be used for its ability to resist corrosion and not react when exposed to one or more chemicals that may be contained within the liquid growth medium. Alternatively, aluminum may be selected based on properties such as a strength-to-weight ratio.

The growth tray 102 may be coupled to a liner (not shown). The liner may be suitably adapted to provide a non-reactive surface for the liquid growth medium to flow over. Further, the liner may be suitably configured to provide a substantially water tight seal within the receiving area to reduce a likelihood of leakage.

The growth tray 102 may also be oriented in any suitable manner to facilitate flow of the liquid growth medium from the first end 114 to the second end 116. Referring now to FIG. 3, in one embodiment, the floor section 302 of the growth tray 102 may comprise tray supports 304. The tray support 304 may comprise a first end 306 and a second end 308. The trays supports 304 are oriented in a generally sloping nature such that the first end 306 has a higher elevation than the second end 308. The elevation change between the first and second ends 306, 308 may comprise any suitable height to allow for a substantially continuous flow of the liquid growth medium along the length of the growth tray 102. For example, the first end 306 may be positioned a height between one-third of an inch and twenty inches above the second end 308. The height differential between the first and second ends 306, 308 may be determined according to any suitable criteria such as the length of the growth tray between the first and second ends 306, 308 and/or a desired flow rate of the liquid growth medium from the first end 306 to the second end 308.

The height differential may be created by any suitable device or method. For example, in one embodiment, a sub-structure 118 may be positioned under the growth tray 102 to elevate and support the growth tray 102 above ground level. The sub-structure 118 may be suitably configured to provide a sloping surface that the floor section 302 may be positioned upon. The sub-structure 118 may be further configured to be adjustable such that the elevation change may be selectively altered to account for any desired changes such as to the flow rate of the liquid growth medium or the particular needs of the plant positioned in the receiving area 104. For example, the sub-structure 118 may be mounted on castors 120 where the height of the castors 120 is adjustable. The height of the castors 120 may be configured to provide a slope or to provide a substantially level surface when the surface on which they sit is not perfectly horizontal.

The sub-structure 118 may comprise a plurality of adjustment mechanisms 121, which elevate and support the growth tray 102 above ground level. The adjustment mechanism 121 allows the height of the sub-structure 118 to be vertically adjustable. The adjustment mechanisms 121 may be suitably configured to provide a sloping surface that the sub-structure 118 and growth tray 102 may be positioned upon. Alternatively, the adjustment mechanisms 121 may be suitably configured to account for imperfections in the surface where the hydroponic growth system 100 resides.

In an alternative embodiment, the floor section 302 of the growth tray 102 may be suitably configured to form the desired amount of elevation change between the first and second ends 114, 116. In yet another embodiment, the elevation difference may be generated by a naturally occurring slope of the surrounding terrain or a sloped flooring system.

The delivery system 106 delivers the liquid growth medium to the receiving area 104 of the growth tray 102. The delivery system 106 may comprise any suitable system or device for circulating or otherwise supplying the liquid growth medium. The delivery system 106 may comprise any suitable combination of storage devices, flow generators, and/or mixing systems. Referring now to FIGS. 1-3, in one embodiment, the delivery system 106 may comprise a fluid reservoir area 122 coupled to a recirculation system 124. The delivery system 106 may further comprise a drain system 126 coupled to the second end 116 of the growth tray 102.

The fluid reservoir area 122 may be adapted to collect a volume of the liquid growth medium to be supplied to the growth tray 102. For example, the fluid reservoir area 122 may comprise a tank 128 suitably configured to receive a flow of the liquid growth medium from the recirculation system 124 or any other suitable supply source. In one embodiment, the fluid reservoir area 122 may be positioned proximate to, and in fluid communication with, the first end 114 of the growth tray 102.

The tank 128 may comprise any suitable shape or size. For example, the tank 128 may comprise a substantially rectangular cuboid with a base portion and four wall elements that extend upwardly from the base portion. Three wall elements may have an upper surface of about equal height above the base portion of the tank 128. A height of the fourth wall element may be less than the height of the three other wall elements, such that when the tank 128 is filled with the liquid growth medium to a level equal to a height of the fourth wall element any excess liquid growth medium pumped into the tank 128 will overflow the tank 128 and flow into the growth tray 102.

Alternatively, the tank 128 may comprise a circular or oval shaped reservoir having a single wall section that extends upwardly from a base. A portion of the single wall section may comprise a lip located at a position below that of the remaining portions of the single wall section. Accordingly, as the level of the liquid growth medium in the tank 128 reaches the lip, any excess will overflow and exit the tank 128 via the lip and flow into the growth tray 102.

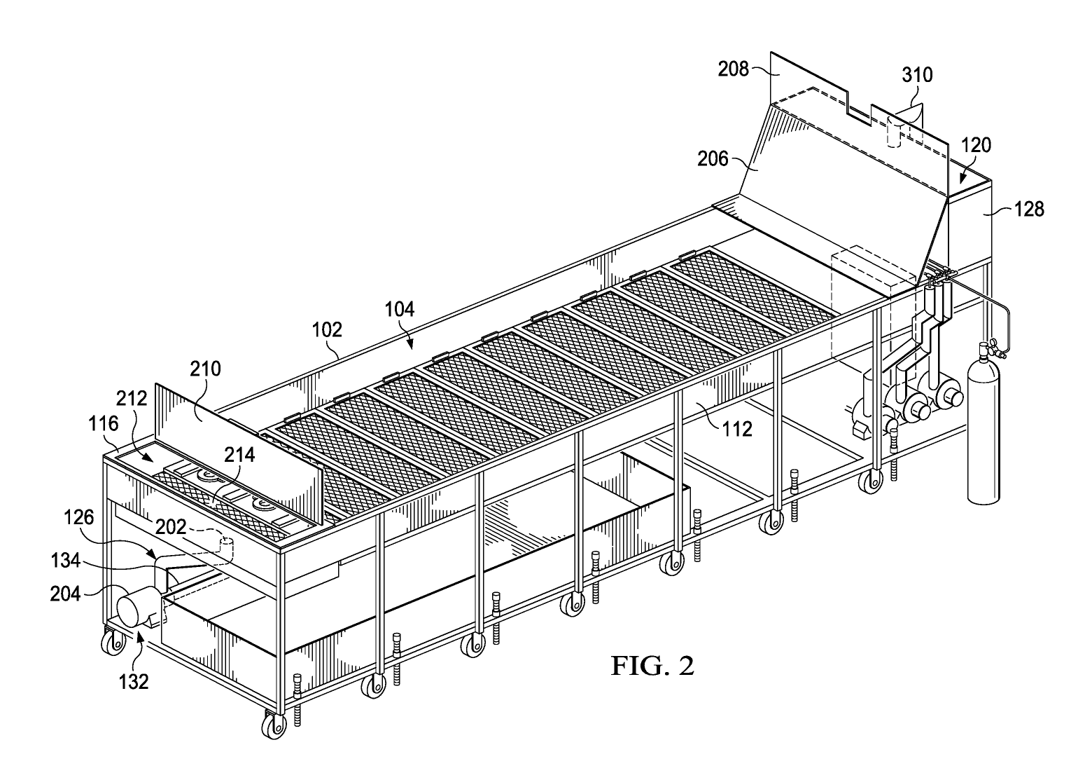

With reference to FIGS. 2 and 3, a waterfall tray 330 may be positioned and suitably configured to collect the overflowing liquid growth nutrients and direct the flow downward into the receiving area 104 under the force of gravity. The FIG. 3 waterfall tray 330 is hidden by a cover 206 shown in FIG. 2. The covers 208, 210 are used to cover the tank 128 and a sump 212 located at the second end 116 of the growth tray 102. The cover 210 is utilized to cover the sump 212, which may comprise a filter 214. The filter 214 operates to inhibit any residue or particles, which may fall off of the plant. The filter 214 may be made from any suitable material. In one embodiment the filter 214 may comprise perforated stainless steel with ridges to allow for more surface area. The covers 206, 208, 210 are utilized to inhibit light from contacting the liquid, nutrients, etc. Direct exposure to sunlight and/or ultraviolet and the like reduces the growth and formation of root hairs. Restricting light from reaching the liquid may provide several benefits. Algae and fungus growth is increased when nutrient enhanced water is contacted by direct light. The root tips and root hairs of the plant are also sensitive to ultraviolet light and will burn if exposed to direct contact. Once a root tip or root hair is burned, the plant is rendered essentially useless as the root tip or root hair cannot be repaired and the amount of nutrients the plant can absorb is dramatically decreased. Extensive exposure to light may also cause root rot, which essentially causes plant product to rot from the inside out and renders the plant product unusable. Thus, limiting the amount of light that the plant roots are exposed to helps maintain healthy plants for optimal plant product production.

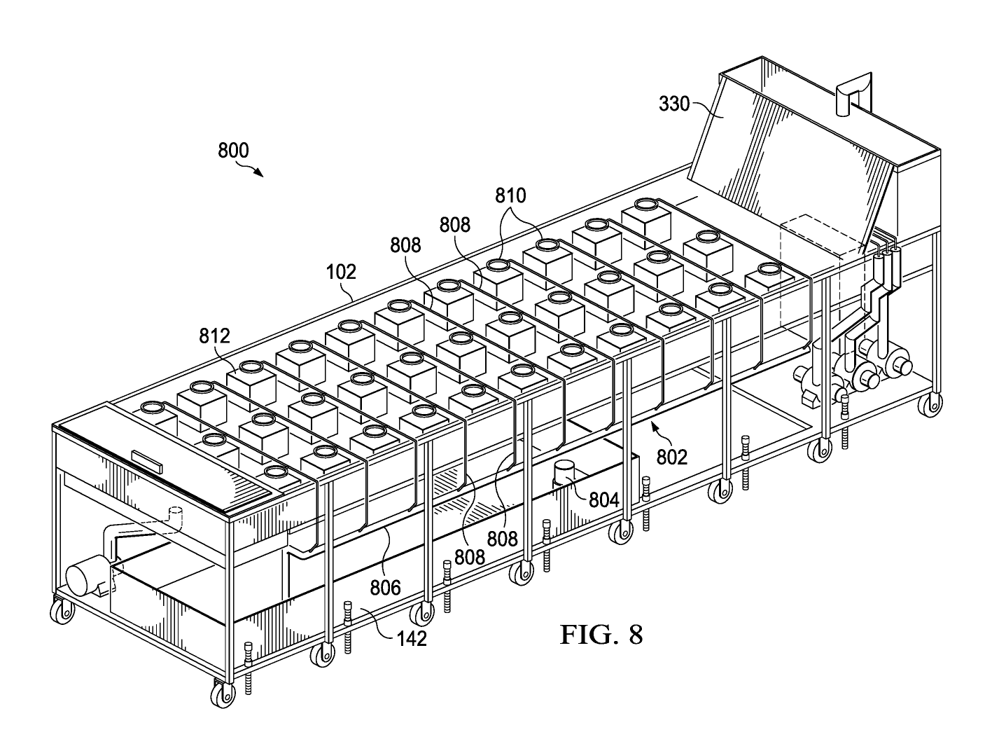

The waterfall tray 330 may comprise any suitable device or system for collecting a liquid and controllably directing the flow of the liquid to a desired location. For example, in one embodiment, the waterfall tray 330 may comprise a generally sloping surface extending between top of the tank 128 and the growth tray 102. The waterfall tray 330 may extend fully downward to the floor section 302 of the receiving area 104 or terminate some distance above the floor section 302. In one embodiment, shown in FIG. 3, the waterfall tray 330 may comprise agitators, to agitate the flow of liquid between the tank 128 and the growth tray 102. In another embodiment, as shown in FIG. 8, the waterfall tray 330 may be substantially smooth.

The waterfall tray 330 may comprise any suitable slope or form any suitable angle or path between the upper surface of the fourth wall element and the floor section 302 of the growth tray 102 such as a single flat surface, a series of slopes or steps, a curved surface, and the like. For example, in one embodiment, the waterfall tray 330 may form a slope of between fifty and seventy degrees relative to a horizontal surface of the growth tray 102. In a second embodiment, the waterfall tray 330 may comprise a more gradually sloped surface of between ten and thirty degrees from the horizontal surface of the growth tray 102.

Referring again to FIGS. 2 and 3, a fluid nozzle 310 may be positioned at or near an upper surface of the tank 122. In one embodiment, a plurality of fluid nozzles 310 may be positioned a predetermined height above an open end of the tank 128 and be configured to inject the liquid growth medium into the tank 128 to agitate a surface level of the tank 128 and assist with aerating the liquid growth medium. Alternatively, one or more fluid nozzles 310 may be positioned within the tank 128.

The fluid nozzle 310 may comprise any suitable device or apparatus for injecting the liquid growth medium into the tank 128 such as a sprayer, an aerating injector, a selectively adjustable valve, or an open end of a pipe. The fluid nozzle 310 nozzle may be coupled to any suitable supply source of the liquid growth medium such as a clean water source and/or the recirculation system 124.

The delivery system 106 may further comprise a nutritional mixing system configured to dissolve or mix one or more nutritional elements such as calcium, magnesium, potassium, nitrate, sulfate, phosphate, copper, iron, zinc, and the like into the liquid growth medium. In one embodiment, the nutritional mixing system may comprise an inlet coupled to a clean water source and an outlet in fluid communication with the tank 128 and/or coupled to a recirculation line (not shown). The nutritional mixing system may dissolve nutrients into the incoming fluid and eject a nutrient enriched solution that may form, at least in part, the liquid growth medium.

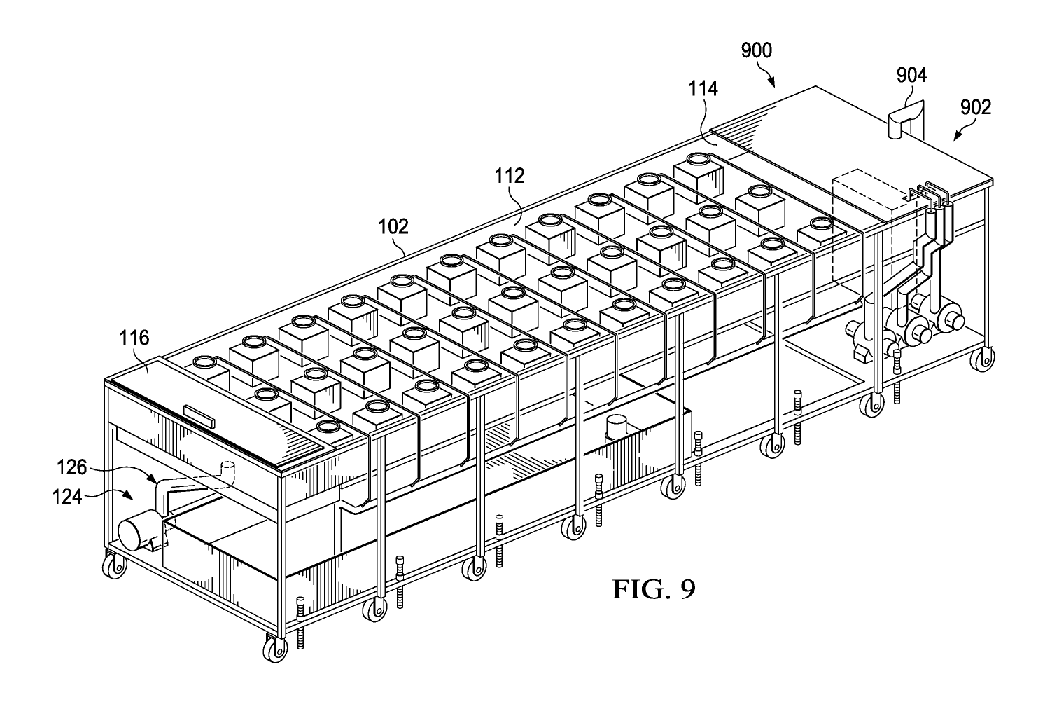

In another embodiment, shown in FIG. 9, a delivery system 900 is shown without a waterfall. In the absence of the waterfall the delivery system 900 operates in a manner very similar to the delivery system 106 described above. The delivery system 900 may comprise a fluid reservoir area 902 coupled to the recirculation system 124. The delivery system 900 may further comprise the drain system 126 coupled to the second end 116 of the growth tray 102.

The fluid reservoir area 902 may be adapted to collect a volume of the liquid growth medium to be supplied to the growth tray 102 from a fluid nozzle 904. For example, the fluid reservoir area 902 may be suitably configured to receive a flow of the liquid growth medium from the recirculation system 124 or any other suitable supply source. In one embodiment, the fluid reservoir area 902 may be positioned proximate to, and in fluid communication with, the first end 114 of the growth tray 102.

The fluid reservoir area 902 may comprise any suitable shape or size. For example, the fluid reservoir area 902 may comprise a substantially rectangular cuboid with a base portion and three wall elements that extend upwardly from the base portion. The wall elements may have an upper surface of about equal height the sidewall 112 of the growth tray 102. In one embodiment, the wall elements may be separate from and attached to the sidewall 112. In another embodiment the wall elements may be combined with the sidewall 112. The fluid reservoir area 902 is arranged as such that when the liquid growth medium is pumped into the fluid reservoir area 902, the liquid growth medium flows into the growth tray 102.

Referring now to FIGS. 1B, 2 and 3, the recirculation system 124 may be configured to collect the liquid growth medium at the second end 116 and recirculate the liquid growth medium to the first end 114 for reuse. The recirculation system 124 may comprise any suitable system for redirecting the flow of the liquid growth medium. In one embodiment, the recirculation system 124 may comprise a pump system 132 and one or more fluid flow channels or recirculation line 134 for directing the liquid growth medium from the drain system 126 to the fluid nozzle 310.

The pump system 132 may be used to move liquid growth medium collected at the second end 116 of the growth tray 102 to the tank 128 where it can be reused. The pump system 132 may comprise any suitable system or device for causing the liquid growth medium to flow from the second end 116 to the fluid reservoir area 122. In one embodiment, the pump system 132 may comprise one or more fluid pumps and/or filtering systems coupled to a recirculation discharge line 312. For example, a discharge pump 204 may be coupled to a drain 202 by the system discharge line 312 of the drain system 126 and be suitably configured to pump discharge fluid away from the second end 116 growth tray 102.

The pump system 132 may be suitably configured to control the flow rate of the liquid growth medium. For example, in one embodiment the pump system may be configured to provide a flow rate of about one and one-half liters per minute. In a second embodiment, the pump system 132 may be configured to allow for controllable adjustment of the flow rate that may be tailored to any suitable criteria such as a particular type of plant or stage of growth.

The recirculation system 124 may comprise a water chiller 136 located between the pump system 132 and the fluid nozzle 310, which may cool the water prior to reintroduction into the tank 128 since the operation of the pump system 132 may raise the temperature of the water being pumped therethrough. Thus, the option of chilling the water is beneficial to provide water at more preferred growing temperatures. For example, water temperatures above 70 degrees Fahrenheit may result in increased levels of algae growth and bacteria in the water. In one embodiment, the optimal temperature range for growth is approximately 60-70 degrees Fahrenheit.

Referring now to FIGS. 1A, 3, and 7, the hydroponic growth system 100 may further comprise an aeration system 314 adapted to deliver a flow rate of gas to the plurality of growth locations 110. The aeration system 314 may comprise any suitable system and may be integrated into the delivery system 106 or be configured as a standalone system. In one embodiment, the aeration system 314 may comprise a gas line 316 connected to a gas delivery device 318 configured to provide a supply of gas. In an exemplary embodiment, a plurality of gas lines 316 and gas delivery devices 318 may be used.

The gas may comprise any suitable gas or combination of gases such as ambient air, pure oxygen, oxygenated air, and the like. The supply of gas and/or the flow rate of the gas may be selected according to any suitable criteria. For example, in one embodiment, the aeration system 314 may be configured to supply a continuous flow of gas to the plurality of growth locations 110. In a second embodiment, the aeration system 314 may be configured to supply a scheduled flow of gas to the plurality of growth locations 110 that may last from a few seconds to several hours.

The gas delivery device 318 may comprise any suitable device configured to move a gaseous fluid such as a pump. The gas delivery device 318 may be configured to operate via any suitable method such as by electrical motor, an internal combustion engine, an air tank, and the like. The gas delivery device 318 may also be configured to provide for an adjustable flow rate of gas that may be selectively varied according to any desired criteria.

The gas line 316 may provide a conduit for the gas to each of the plurality of growth locations 110. The gas line 316 may comprise any suitable type of conduit such as an air hose. The gas line 316 may be suitably configured to be routed along the floor section 302 of the growth tray 102 and under the tray system 108. The gas line 316 may be arranged as a single hose routed along the floor section 302 or the gas line 316 may comprise a plurality of hoses routed in any suitable direction. For example, in one embodiment, the gas line 316 may comprise a series of three hoses running the length of the growth tray 102 from the first end 114 to the second end 116. A first hose 702 may be positioned such that it is proximate one of the opposing sidewall elements 112 and a second hose 704 may be positioned such that it is proximate the other sidewall element 112. A third hose 706 may be poisoned along a center portion of the receiving area 104 about half-way between the pair of opposing sidewall elements 112.

The aeration system 314 may further comprise a bubbler system 320 coupled to the gas line 316. The bubbler system 320 may be configured to release a portion of the gas from the gas line 316. For example, in one embodiment, the bubbler system 320 may comprise a plurality of bubbler elements 708 wherein at least one bubbler element 708 is positioned at each of the plurality of growth locations 110. As the gas is flowed through the gas line 316, a portion of the gas may be released by the bubbler element 708 into the liquid growth medium substantially underneath the plant.

The bubbler elements 708 may comprise any suitable device for releasing an amount of gas. In one embodiment, the bubbler element 708 may comprise an injector or an educator. The bubbler element 708 may be suitably adapted to provide a fixed amount of the gas at each of the plurality of growth locations 110 or the bubbler element 708 may be configured to be adjustable such that an amount of gas released at each growth location 110 may be individually controlled. For example, the bubbler element 708 may comprise an oxygen diffuser configured to stimulate the roots by providing the roots with increased levels of oxygen and/or nano bubbles.

The aeration system 314 may further comprise an oxygen injector system 322 coupled to the gas line 316. The oxygen injector system 322 may comprise a cylinder 324 filled with oxygen, which may be introduced into the gas lines 316 via an oxygen line 326 and a valve 328. Introduction of additional oxygen may help stimulate the roots of the plant, which increases the amount of nutrients they uptake, as well as the frequency in which they uptake nutrients, thereby promoting faster and healthier growth to the plant. While shown adjacent to the hydroponic growth system 100, the oxygen injector system 322 may be placed in other locations and piped into the aeration system 314.

The delivery system 106 may further comprise a nutritional mixing system configured to dissolve or mix one or more nutritional elements such as calcium, magnesium, potassium, nitrate, sulfate, phosphate, copper, iron, zinc, and the like into the liquid growth medium. In one embodiment, the nutritional mixing system may comprise an inlet coupled to a clean water source and an outlet in fluid communication with the tank 128 and/or coupled to a recirculation line (not shown). The nutritional mixing system may dissolve nutrients into the incoming fluid and eject a nutrient enriched solution that may form, at least in part, the liquid growth medium.

Referring now to FIG. 1B, the hydroponic growth system 100 may further comprise a flood system 140 adapted to deliver a nutrient solution to the plurality of growth locations 110 in the growth tray 102. The flood system 140 may comprise a reservoir 142, a flood pump 144, and a flood drain 146. The flood system 140 may be connected to the recirculation system 124. The flood pump 144 pulls the nutrient solution from the reservoir 142 via an inlet line 148 and delivers the nutrient solution to the recirculation line 134 via the outlet line 150. The flood drain 146 may comprise a valve 152 and a return line 154 that is configured to route at least a portion of the nutrient solution collected at the sump 212 at the second end 116 of the growth tray 102 to the reservoir 142 for reuse via the pump system 132.

The flood system 140 may further comprise a nutritional mixing system configured to dissolve or mix one or more nutritional elements such as calcium, magnesium, potassium, nitrate, sulfate, phosphate, copper, iron, zinc, and the like into the liquid growth medium. In one embodiment, the nutritional mixing system may comprise an inlet coupled to a clean water source and an outlet in fluid communication with the reservoir 142 and/or coupled to the recirculation line 134. The nutritional mixing system may dissolve nutrients into the incoming fluid and eject a nutrient enriched solution that may form, at least in part, the liquid growth medium.

Referring now to FIG. 8, the hydroponic growth system 100 may further comprise a top feed system 800 adapted to deliver a nutrient solution to the plants on the plurality of growth locations 110. The top feed system 800 may comprise a conveyance system 802 and a pump 804. The conveyance system 802 may comprise a flow tube 806 and a plurality of irrigation lines 808. A plurality of drip rings 810 may be attached to the irrigation lines 808 and aligned to irrigate a plurality of plant mediums 812 containing the plants. Any suitable plant mediums 812 may be used. In one embodiment, the plant mediums 812 may comprise a GRODAN® Rockwool Starting Block, measuring 8″×8″×8″. The plants are placed within the plant mediums 812 which allow the plant to grow upwardly while the roots of the plant can grow downwardly. The drip rings 810 surround the plant base and are configured to delivery nutrients thereto. The pump 804 pulls the nutrient solution from the reservoir 142 via a flow tube 806 and delivers the nutrient solution to the growth locations 110 via the plurality of drip rings 810 located on the irrigation lines 808.

Referring now to FIGS. 3 and 6-8, the plant mediums 812 are positioned on the open areas 602. The plant mediums 812 align with the growth locations 110 and the bubbler elements 708 on the bubbler system 320. This allows the top feed system 800 to work in conjunction with the recirculation system 124 and the aeration system 314, as will be discussed in detail below. The plant mediums 812 provide an area where the roots of the plant may grow downward to a constant source of dissolved oxygen from the bubbler system 320. The dissolved oxygen stimulates the root hairs, which increases the amount of nutrients they uptake, as well as the frequency in which they uptake nutrients, thereby promoting faster and healthier growth to the plant.

The top feed system 800 flushes the plant and the flow rate of the water can be as slow as a drip or as fast as 25 gal of water a min. The top feed system 800 may further comprise a nutritional mixing system configured to dissolve or mix one or more nutritional elements such as calcium, magnesium, potassium, nitrate, sulfate, phosphate, copper, iron, zinc, and the like into the liquid growth medium. In one embodiment, the nutritional mixing system may comprise an inlet coupled to a clean water source and an outlet in fluid communication with the reservoir 142. The nutritional mixing system may dissolve nutrients into the incoming fluid and eject a nutrient enriched solution that may form, at least in part, the liquid growth medium.

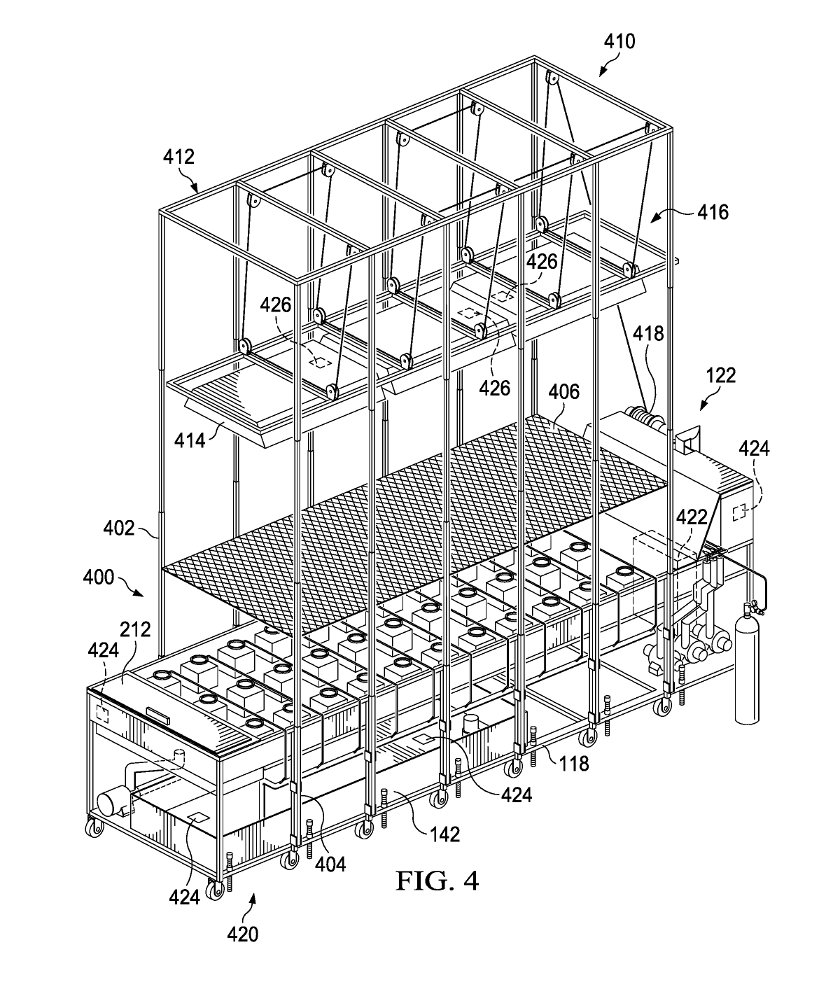

Referring now to FIG. 4, the hydroponic growth system 100 may further comprise a trellis system 400. The trellis system 400 may comprise a plurality of posts 402 and is connected to a plurality of support posts 404 on the sub-structure 118. The trellis system 400 may comprise a support 406 oriented generally horizontally and spaced a vertical distance from the top of the sidewall 112 of the growth tray 102. In one embodiment, the support 406 may comprise a wire screen configured to support the plant as it grows upwardly such that the plant product does not cause branches of the plant to break. Multiple supports 406 may be used to support increase growth of the plant within the plant medium 812. For example, a first wire screen may be placed at an approximate distance of 12 inches above the plant medium 812. Once the plant has reached a certain height, a second wire screen may be placed at an approximate distance of 48 inches above the plant mediums 812 to further support the growth of the plant. Essentially any configuration of number and distance of support 406 placement may be contemplated to support the plants, stalks, upper branches, and plant product to accommodate growth of plants in any range of sizes.

The hydroponic growth system 100 may further comprise a lighting system 410. The lighting system 410 may be coupled to the trellis system 400. The lighting system 410 comprises a support structure 412 having a number of lights 414 attached thereto. The lighting system 410 may be raised or lowered by a pulley system 416 located the support structure 412 and a winch 418 attached to the fluid reservoir area 122. Thus, the user may raise or lower the lighting system by activating the wench 418.

Referring to FIG. 4 a monitoring system 420 is shown. The monitoring system 420 may comprise a number of sensors configured to monitor different parameters of the hydroponic growth system. In one embodiment the monitoring system 420 may comprise hand held monitors where the operator may view the readings from the sensors of the components of the hydroponic growth system 100. In one embodiment, the monitoring system 420 may comprise control box 422 configured to monitor each of the components of the hydroponic growth system 100. For example, the control box 422 may be configured to monitor the pump system 132, the flood pump 144, the discharge pump 204, the gas deliver device 318, the water chiller 136, and pump 804. Additionally, the control box 422 may be configured to monitor any other component of the hydroponic growth system 100 contemplated by the operator.

In one embodiment the sensor may comprise solution sensors 424 that are configured to monitor different variables in the nutrient solution in the hydroponic growth system 100. In one embodiment, the solution sensors 424 may be placed in one or all of the reservoir 142, the fluid reservoir area 122, and the sump 212. It should be understood that solution sensors 424 may be placed throughout the hydroponic growth system 100 in any area the operator deems necessary to collect data.

The solution sensors 424 may be configured to monitor pH, PPM, temperature, and/or conductivity, depending on the parameters need by the operator. The solution sensors 424 may provide readings to hand held units, the control box, or remote locations. The solution sensors 424 may be hardwired or configured to send information via Wi-Fi or any other contemplated medium. The solution sensors 424 may communicate with handheld readers, the control box, or a remote monitoring system.

In one embodiment, the sensors may comprise light sensors 426. The light sensor 426 may be placed on each individual light 414. Each of the light sensors 426 detects an absence of light and upon detection will notify the operator. In one embodiment, the light sensor 426 may comprise a phototrophic sensor which only reads whether that the light is activated. The light sensor 426 may be placed such that only the adjacent light can trigger the light sensor 426. The light sensor 426 may be configured to ensure that each of the lights 414 is operating correctly. In the event that the light 414 is not operating, the light sensor 426 will send a message to the operator that the specific light is malfunctioning so that the light can be replaced immediately.

The tray system 108 may provide a more optimized spacing arrangement within the receiving area 104 for the one or more plants. The tray system 108 may comprise any suitable system or device for determining an arrangement for the one or more plants. The tray system 108 may comprise any suitable material. In one embodiment, the tray system 108 may comprise high grade stainless steel. The tray system 108 may be arranged within the receiving area 104 between the first and second ends 114 116. The tray system 108 may comprise a substantially rectangular shape having a length configured to extend between the pair of opposing sidewall elements 112 and a width of between eight and thirty inches. The tray system 108 may also be configured to be selectively removable from within the receiving area 104 to allow for cleaning, harvesting, pruning, and/or removal of diseased or distressed plants to prevent spread to the remaining plants.

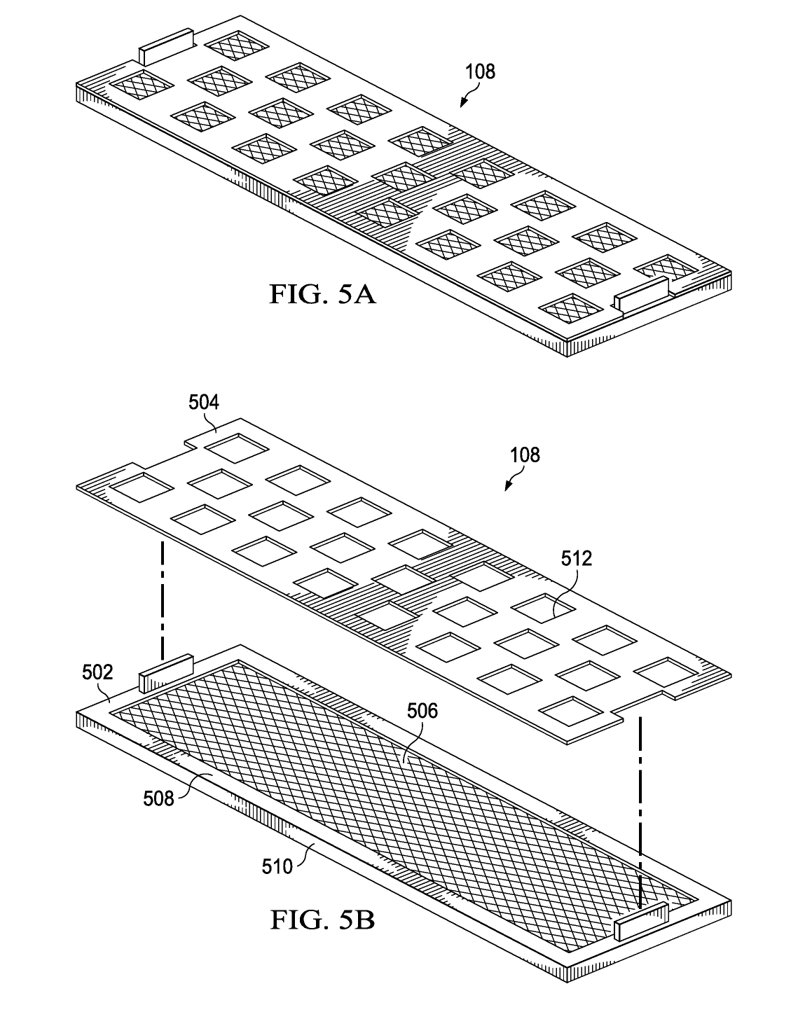

Referring now to FIGS. 5A, 5B, 6A, 6B, and 7, in one embodiment, the tray system 108 may comprise a base tray 502 and an overlay module 504, 604. The base tray 502 may comprise a mesh grid 506 and support portion 508. The mesh grid 506 may be configured to limit an amount of the plant that is positioned below a level of the liquid growth medium. The support portion 508 may comprise a substantially rectangular shaped perimeter with a pair of spaced apart downwardly depending sidewalls 510, which reside on the tray supports 304, when installed. The base tray 502 and overly modules 504 may be configured in multiple orientations and in any suitable manner. In one embodiment, the base tray 502 may extend from approximately the first end 114 of the growth tray 102 to approximately the second end 116 of the growth tray 102. In another embodiment, the base tray 502 may comprise multiple pieces arranged from the first end 114 of the growth tray 102 to approximately the second end 116 of the growth tray 102. The overly modules 504 may also be arranged in a manner similar to that described above with respect to the base tray 502.

In an exemplary embodiment, shown in FIGS. 5A and 5B, the overlay module 504 may comprise a plurality of open areas 512 configured to receive a single plant. The open area 512 may comprise any suitable shape or size. For example, in one embodiment, the open area 512 may comprise a substantially square opening having sides of between four and twelve inches. The open area 512 may be suitably configured to more directly expose a root system of the plant to the bubbler element 708 while decreasing an amount of light exposure by the root system. In this manner, the gas emitted or otherwise released into a region immediately adjacent to the root system may be increased.

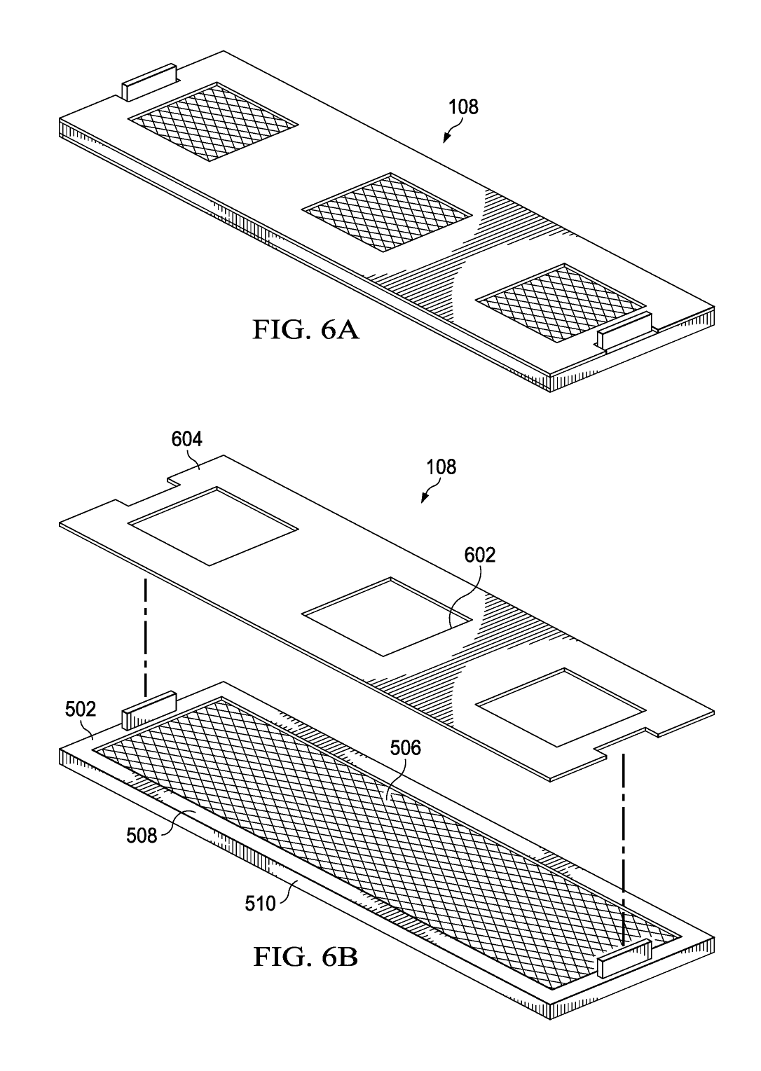

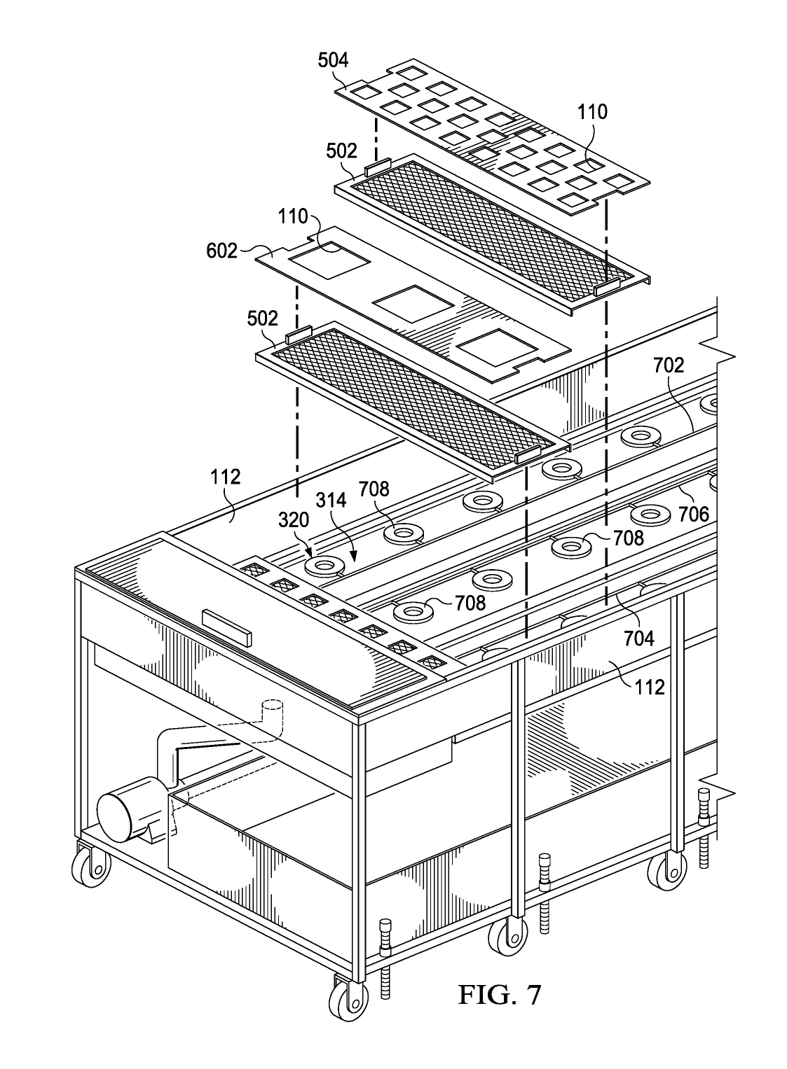

The number of open areas 512 contained in any given overlay module 504 may be determined according to any suitable criteria such as the expected dimensions of a fully grown plant. As shown in FIGS. 5A and 6A different configurations of open areas 512, 602 contained in any given overlay module 504, 604 may be contemplated. In one embodiment, as shown in FIG. 7, the plurality of overlay modules 604 may comprise a plurality of 3 zone trays 604, shown in FIG. 6A, and the plurality of overlay modules 504, plurality of multiple zone trays 504, shown in FIG. 5A. Additionally, as shown in FIG. 1A, a plurality of multiple zone trays 504, shown in FIG. 5A may be utilized. Further, as shown in FIG. 4A, a plurality of three zone trays 604, shown in FIG. 6A may be utilized. It should be understood that the open areas 512, 602 correspond to the growth locations 110.

In one embodiment, a three zone tray 604 may comprise three open areas 602, wherein each open area 602 is configured to be positioned over bubbler element 708. For example, the three zone tray 604 may be configured such that the three open areas 602 are positioned over corresponding bubbler element 708. In another embodiment, the multiple zone trays 504 may comprise any suitable number of open areas 512 that may be positioned over bubbler element 708. The multiple zone trays 504 can be arranged in any configuration based on the type and size of the plants to be grown.

The trays 504, 604 may comprise any suitable shape or dimension. For example, in one embodiment, the trays 504, 604 may comprise a substantially rectangular shape having a length configured to extend between the pair of opposing sidewall elements 112 and a width of between eight and thirty inches. Similarly, the trays 504, 604 may comprise a substantially rectangular shape having a length configured to extend between the pair of opposing sidewall elements 112 and a width of between eight and thirty inches. Alternatively, the trays 504, 604 may comprise a substantially rectangular shape having a length configured to extend only part way between the pair of opposing sidewall elements 112 resulting in an open space between each of the pair of opposing sidewall elements 112 and end portions of the trays 504, 604. The open space may then be closed off with a closure tray that does not comprise an open area. Alternatively, the trays 504, 604 may extend from the first end 114 of the growth tray 102 to approximately the second end 116 of the growth tray 102.

By alternating placement of the multiple zone trays 504 and three zone trays 604 adjacent to each other, a more uniform spacing arrangement may be achieved that allows the plants to grow with a reduced likelihood of being crowded by a neighboring plant.

The base tray 502 and an overlay module 504 may comprise any suitable material such as metal, plastic, stone, or composite. The material may be selected according to any suitable criteria such as weight, cost, heat transfer properties, and/or ability of the material to be exposed to the liquid growth medium without reacting. For example, the base tray 502 and an overlay module 504 may comprise stainless steel. In an alternative embodiment, base tray 502 and an overlay module 504 may comprise aluminum.

Operation

In operation, a growth tray 102 may be in fluid communication with a delivery system 106 configured to provide a pre-determined flow rate of a liquid growth medium from a first end 114 of the growth tray 102 to a second end 116 of the growth tray 102. The growth tray 102 may also be in fluid communication with a recirculation system 314 that is configured to return at least a portion of the liquid growth medium to a reservoir of the delivery system 106 for reuse.

The growth tray 102 may also be in fluid communication with a flood system 140 adapted to deliver a nutrient solution to the plurality of growth locations 110 in the growth tray 102. The flood pump 144 pulls the nutrient solution from the reservoir 142 and delivers the nutrient solution to the growth tray 102 and may return at least a portion of the nutrient solution collected at the reservoir 142 for reuse. The growth tray 102 may also be in fluid communication with the top feed system 800 that is configured to deliver the nutrient solution from the reservoir 142 to the growth locations 110 via the plurality of drip rings 810 located on the irrigation lines 808.

The delivery system 106 may comprise a waterfall tray 330 that provides a sloping flow path from the delivery system 106 to the growth tray 102. As the liquid growth medium flows down the waterfall tray 330, an oxygen level of the liquid growth medium may be increased before entering a receiving area 104 of the growth tray 102. After entering the first end 114 of the growth tray 102, the liquid growth medium may then begin flowing towards the second end 116.

One or more plants may be arranged throughout the receiving area 104 by a tray system 108 such that the root system of each plant is exposed to the flowing liquid growth medium. In addition to being exposed to the liquid growth medium, a flow rate of gas may be supplied to each plant by a bubbler element coupled to an aeration system configured to pump the gas to the bubbler element.

The delivery system 106, aeration system 314, flood system 140, and top feed system 800 can be used either singly or on combination with one another. For example, in one embodiment, the flood system 140 can draw water containing the nutrient solution from the reservoir 142 filling the growth tray with the nutrient solution. The aeration system 314 may also be activated and the bubbler system 320 would provide oxygen to stimulate and oxygenate the plants. To remove the nutrient solution from the reservoir 142, the flood drain utilized. The user may active the valve 152 to route at least a portion of the nutrient solution collected at the sump 212 at the second end 116 of the growth tray 102 to reservoir 142 for reuse via the pump system 132. The removal of the nutrient solution via the pump system 132 pulls fresh oxygen from the atmosphere into the plant at the growth locations 110 via the natural process of gravity. In another embodiment, the nutrient solution may by cycled to waste.

In another embodiment the delivery system 106 may be used in combination with a waterfall tray 330 that provides a sloping flow path from the fluid reservoir area 122 to the growth tray 102. After entering the first end 114 of the growth tray 102, the liquid growth medium may then begin flowing towards the second end 116. The recirculation system 124 provides a constant flow while in use.

In another embodiment, the delivery system 106 may be used in combination with the flood system 140. The delivery system 106 may run constantly while the flood system 140 may be cycled on and off according to the preference of the user. In this embodiment the roots under the growth locations 110 are stimulated as well as the roots in the plant contained in the plant medium 812.

In another embodiment, the delivery system 106 may be used in combination with the top feed system 800. The delivery system 106 may run constantly while the top feed system 800 may be used to mimic rainfall on the plants. In this embodiment the roots under the growth locations 110 are stimulated as well as the roots in the plants contained in the plant mediums 812 from above, which is similar to what occurs in nature.

In another embodiment, the delivery system 106, flood system 140, and top feed system 800 may be used in combination with one another. The delivery system 106 is run constantly and the aeration system 314 is activated such that the bubbler system 320 provides oxygen to stimulate and oxygenate the plants. During the beginning of a cycle, when the plants are small, the top feed system 800 delivers the nutrient solution from the reservoir 142 to the growth locations 110 via the plurality of drip rings 810. The top feed system 800 is critical at the beginning of the cycle because of the small size of the plant contained in the plant mediums 812. At the end of the cycle, the flood system 140 will be activated to fill the growth tray 102 with the nutrient solution from the reservoir 142 until the plants are suitably immersed. The flood system 140 will then be deactivated by the valve 152 and the nutrient solution will routed to reservoir 142 for reuse via the pump system 132. The nutrient level in the growth tray 102 will remain sufficient for the bubbler system 320 to provide oxygen to stimulate and oxygenate the plants.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A hydroponic growth system for delivering a liquid growth medium to a plurality of plants in a growth tray having a first end and a second end with generally opposing wall elements, a pair of generally opposing sidewall elements extending between the first and second ends, and a floor extending along a lower portion of the generally opposing sidewall elements between the first and second ends to form a receiving area, the system comprising:
a tray system disposed within the receiving area, wherein the tray system comprises a plurality of receiving modules configured to receive the plurality of plants;
a delivery system configured to circulate the liquid growth medium into the receiving area between the first and second ends of the growth tray;
an aeration system may be used to provide an individualized flow of a gas to each plant in the growth tray;
a flood system configured to deliver a nutrient solution to the to the plurality of plants;
a top feed system configured to deliver a nutrient solution to the to the plurality of plants; and
a lighting system configured to deliver light to the to the plurality of plants.

2. A hydroponic growth system according to claim 1, wherein the aeration system is configured to provide a gas to each plant.

3. A hydroponic growth system according to claim 2, wherein the aeration system comprises:
a gas delivery device extending between the first and second ends and disposed between the tray system and the floor; and
an oxygen diffuser connected to the gas line.

4. A hydroponic growth system according to claim 3, wherein the gas delivery device is adapted to control a flow rate of the gas to the plurality of receiving modules.

5. A hydroponic growth system according to claim 4, wherein the gas delivery device comprises a bubbler system having a plurality of oxygen diffusers positioned proximate to each of the plants and configured to eject a portion of the gas.

6. A hydroponic growth system according to claim 1, wherein the delivery system comprises:
a fluid reservoir area proximate to and in fluid communication with the first end of the receiving area;
a drain system disposed in the floor proximate the second end, wherein the drain system is configured to collect the liquid growth medium; and
a recirculation system coupled between the fluid reservoir area and the drain system, wherein the recirculation system is configured to pump the liquid growth medium from the outlet to the fluid reservoir area.

7. A hydroponic growth system according to claim 6, wherein the fluid reservoir area comprises:
a tank disposed proximate to the first end;
a nozzle coupled to the recirculation system and disposed a predetermined height above the tank, wherein the nozzle is configured to flow the liquid growth medium into the tank from the predetermined height; and
a waterfall tray configured to provide a sloping flow path for the liquid growth medium from the tank to the receiving area.

8. A hydroponic growth system according to claim 6, wherein the recirculation system comprises:
a drain pump coupled to the drain system by a discharge line; and
a recirculation pump coupled between the drain pump and the fluid reservoir area by a recirculation line.

9. A hydroponic growth system according to claim 8, wherein at least one of the recirculation and the drain pump are configured to control a flow rate of the liquid growth medium.

10. A hydroponic growth system according to claim 1, further comprising a reservoir coupled to the flood system and top feed system and configured to deliver a nutrient solution to the plurality of growth locations.

11. A hydroponic growth system according to claim 1, wherein the plurality of receiving modules comprise:
a base tray having a mesh grid; and
an overlay module with an open area, wherein the open area is configure to receive a plant.
